(19) United States
(12) Patent Application Publication
(10) Pub. No.: US 2003/0029790 A1
(43) Pub. Date: Feb. 13, 2003

(54) Method and apparatus for introducing a moving liquid into a larger mass of moving liquid

(76) Inventor: Steven James Templeton, Cotterell (GB)

Correspondence Address: Gerald T Shekleton, Welsh & Katz, 120 South Riverside Plaza, 22nd Floor, Chicago, IL, 60606, US

(21) Appl. No.: 10/019,973

(22) PCT Filed: Mar. 12, 2001
(86) PCT No.: PCT/GB01/01065

(30) Foreign Application Priority Data
Mar. 10, 2000 (GB) 0005898.2

(51) Int. Cl. B04C 1/00

(52) U.S. Cl. 210/512.1

(57) ABSTRACT

In a vortex separator for use in at least partially removing suspended solids from a liquid containing suspended solids, the inlet port (8), whereby the liquid is introduced tangentially into a vortex chamber, has a substantially rectangular cross-section at a curved internal wall surface (2) of the chamber and the long axis of the rectangle is preferably aligned substantially parallel with the longitudinal axis of the curved internal wall surface (2). The inlet port (8) preferably has a short side dimension which is not substantially greater than the thickness of the boundary layer of the liquid in the vortex chamber in use, so that the introduced liquid is substantially maintained in the boundary layer of the liquid at the internal wall surface. This arrangement has been found to provide more efficient separation of the solids, which are discharged from the separator via discharge port (7) separately from the clean(er) water, which leaves the separator via the tangential outlet port (6) above the level of the inlet port (8).

The present invention relates to a method and apparatus for introducing a moving liquid into a larger mass of moving liquid, and most particularly to the introduction of a stream of liquid carrying suspended solids (e.g. biocontaminated water) into a larger moving mass of such liquid in a vortex separator for removal of the solids.

The introduction of a moving liquid into a larger mass of moving liquid is known to have attendant difficulties. Turbulence and other disruptive forces can result if the introduction is not performed in an efficient manner, and unless care is taken the liquid to be introduced can be forced back along an inlet duct or the like. Furthermore, the efficiency of introduction can vary according to the inflow rate, the speed of movement of the larger mass of liquid, the density of the liquids and other variables.

The domestic or commercial keeping of fish and other aquatic life in tanks results in continuous contamination of the water with organic matter. Furthermore, the water in swimming pools, ponds, water-holding tanks and garden water features is susceptible to contamination by organic matter such as algae growth and dead plant matter. It is inconvenient and expensive to completely change the water on a daily basis. Recirculating filter systems are conventionally employed, whereby water is withdrawn, the suspended solids are removed, and the clean(er) water is returned.

The removal of such suspended solids is conventionally achieved by a variety of known methods, including gravity separation, vortex separation, membrane filtration, porous block filtration, trickle tower filtration and combinations thereof. The present invention relates particularly to vortex separation.

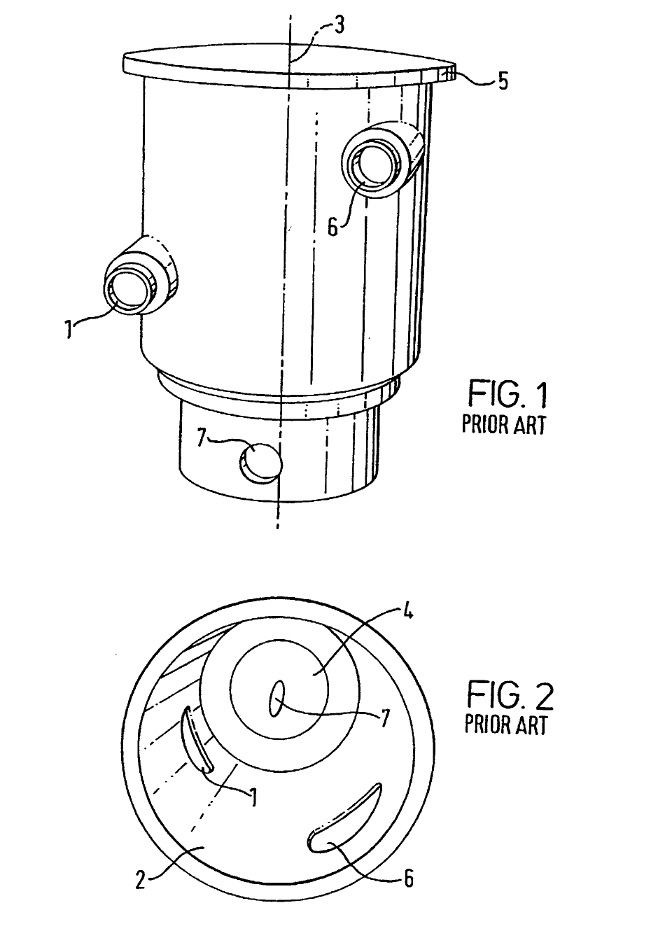

FIGS. 1 and 2 of the accompanying drawings show respectively a front perspective view and an interior perspective view of an example of a known vortex separator for use in removal of suspended solids from a liquid.

The liquid is fed (e.g. under gravity) into a vortex chamber via an inlet port 1. The vortex chamber has a curved internal wall surface 2, and the inlet port 1 for the liquid penetrates this curved internal wall surface 2 and is arranged to cause the liquid to enter the chamber substantially tangentially to the curve of the wall surface. The curved internal wall of the chamber has a longitudinal axis 3 which in use is orientated generally vertically. The base of the chamber is closed by an end wall 4, which defines a conical hopper where the separated solids collect, and the top of the chamber is closable by a removable lid 5 (shown removed in FIG. 2).

The curved internal wall surface of the vortex chamber causes the liquid introduced into the chamber to follow a curved path defined by the curve of the wall surface. This rapidly establishes a vortex in the liquid within the chamber, with a so-called boundary layer at the wall surface, in which boundary layer the frictional effects of the wall surface are substantial and the fluid flow differs from the bulk of the liquid in the vortex.

The effect of the boundary layer causes a concentration of the solids towards the base of the chamber and a corresponding at least partial clearing of the water towards the top of the chamber.

An outlet port 6, penetrating the internal wall surface 2, is provided to convey the clean(er) liquid from the vortex chamber. The outlet port 6 is provided somewhat above the inlet port 1, and is preferably arranged tangentially to the curve of the wall surface 2.

The end wall 4 of the chamber is provided with a solids discharge port 7 and an associated valve, whereby the concentrated solids can be removed.

If desired, two or more vortex separators may be connected in series, to handle larger volumes of water. Vortex separators are conventionally employed with other separators such as filter or trickle tower separators, whereby the clean(er) outflow liquid from the vortex separator is fed directly to the filter or trickle tower separator for further treatment. Alternatively or additionally, porous absorbent and/or nitrifying bacterial media such as reticulated ether material (REM) foam cartridges can be located within the vortex chamber to assist purification of the water.

Examples of such conventional vortex separators for use in aquaculture, pools, ponds etc include the TASKMASTER and FLOWMASTER systems marketed by Nitritech of Bristol, UK (tel: +44 1454 776927; fax: +44 1454 250753).

The known vortex separators are efficient and relatively inexpensive systems providing a reasonable degree of removal of solids from liquids. However, there remains a continuing need for improvements and a continuing research effort to find them.

The present invention is based on the surprising finding that, by configuring an inlet port so as to have a substantially rectangular cross-section and by arranging it so that an introduced liquid enters the larger moving mass of liquid at an internal wall surface of the container for the larger mass of liquid (e.g. the vortex chamber or other apparatus containing the larger mass of liquid) at a sufficiently small angle (e.g. up to about 40°, preferably up to about 30°, and most preferably up to about 20°) to the direction of flow of the larger moving mass of liquid that the introduced liquid is substantially maintained in the boundary layer of the larger mass of liquid at the internal wall surface, a markedly improved efficiency of introduction is achieved, leading in the case of a vortex separator to a markedly improved efficiency of removal of solids.

The present invention may be stated generally to provide in a first aspect a method for introducing a moving liquid into a larger mass of liquid moving in an apparatus (including a duct), the method comprising introducing the first moving liquid into the second via an inlet port which penetrates an internal wall surface of the apparatus, the inlet port having a substantially rectangular cross-section and being arranged so that the introduced moving liquid enters the larger moving mass of liquid at the internal wall surface at a sufficiently small angle (e.g. up to about 40°, preferably up to about 30°, and most preferably up to about 20°) to the direction of flow of the larger moving mass of liquid that the introduced liquid is substantially maintained in the boundary layer of the larger mass of liquid at the internal wall surface.

In a second aspect the present invention may be stated generally to provide an apparatus (including a duct) adapted to contain a relatively large mass of liquid moving therein, and to permit a relatively small mass of moving liquid to be introduced into the relatively large mass, the apparatus having an internal wall surface and comprising an inlet port for the liquid to be introduced, the inlet port penetrating the internal wall surface of the apparatus, wherein the inlet port has a substantially rectangular cross-section and is arranged so that in use the introduced moving liquid enters the larger moving mass of liquid at the internal wall surface at a sufficiently small angle to the direction of flow of the larger moving mass of liquid that the introduced liquid is substantially maintained in the boundary zone of the larger mass of liquid at the internal wall surface.

The phrase “substantially rectangular cross-section” used herein refers particularly to a generally elongate slot-like inlet port. Thus, the phrase is intended to define not only a true rectangle but modified rectangles, for example trapezoids or ports having curved sides, so long as the general form of an elongate slot is preserved. The dimensions and configuration of the substantially rectangular cross-section of the inlet port will be readily selected by one of ordinary skill, having regard to the intended capacity of the system and the intended flow rate of liquid. The short dimension of the rectangle should not, however, generally be substantially greater than the thickness of the boundary layer of the moving liquid in the apparatus in use. This thickness can readily be measured experimentally, as is well known to one of ordinary skill. In general, the larger the short dimension of the rectangle, the smaller must be the angle of incidence of the introduced liquid into the larger mass of liquid. Typically, the ratio of the long:short sides of the rectangle will be in the range of about 3:1 to about 15:1.

It is preferred that the long axis of the rectangle is aligned substantially transverse to the flow direction of the larger moving mass of liquid.

It is preferred that the general (curved) plane of the internal wall surface is not disturbed by extensions or protruberances in the region of the inlet port

As stated above, the present invention is particularly applicable to vortex separators.

Thus, in a third aspect the present invention may be stated generally to provide a vortex separator for use in at least partially removing suspended solids from a liquid, the vortex separator comprising:

(a) a vortex chamber having (i) a curved internal wall surface which has a S longitudinal axis which in use is orientated substantially vertically, and (ii) an end wall closing a base of the chamber;

(b) an inlet port for the liquid, which inlet port penetrates the curved internal surface of the vortex chamber and is arranged to cause the liquid to enter the chamber substantially tangentially to the curve of the wall surface;

(c) an outlet port for the liquid, which penetrates the curved internal wall surface and is arranged to convey the liquid from the chamber after at least some of the suspended solids have been separated from the liquid; and

(d) a discharge port for the suspended solids;

wherein the inlet port has a substantially rectangular cross-section at the internal wall surface of the chamber.

By arranging the inlet port so that the liquid enters the vortex chamber substantially tangentially to the curve of the wall surface, the angle of incidence of the introduced liquid entering the moving mass of liquid in the vortex chamber will be sufficiently small (e.g. no more than about 40°, preferably no more than about 30°, and most preferably no more than about 20°, in view of the typical radius of curvature found in vortex separators) that the introduced liquid is substantially maintained in the boundary zone of the liquid in the chamber in use, which covers the inlet and outlet ports.

As mentioned above, the dimensions and configuration of the substantially rectangular cross-section of the inlet port will be readily selected by one of ordinary skill, having regard to the intended capacity of the system and the intended flow rate of liquid. Thus, for example, in a vortex separator having a chamber capacity of between about 0.5 and about 1.5 cubic metres and an optimum liquid through-flow rate of between about 7 and about 13 cubic metres per hour, a substantially rectangular inlet port having a ratio of the long:short sides of about 7:1 and a cross-sectional area of about 100 to about 220 cm², preferably about 150 to about 200 cm² will be suitable. The long side may suitably be between about 20 cm and about 50 cm in length, preferably about 35 cm, and the short side may suitably be between about 1 cm and about 10 cm in length, preferably about 5 to about 8 cm. The short side length represents the transverse width of the inlet port; as the inlet port penetrates the curved internal wall surface of the vortex chamber, the circumferential length of the short side will increase, typically by a factor of between 1.5 and 2.5, compared with the said transverse width.

As mentioned above, in vortex separators of this type the inlet port is located below the level of the outlet port. The inlet port of the vortex separator according to the present invention preferably penetrates the internal wall surface of the vortex chamber over a top or bottom length corresponding to the majority (i.e. at least 50%) of the lower half of the chamber. The top of the inlet port should, however, still be below, preferably substantially below, the outlet port. The outlet port correspondingly should be positioned well within the upper half of the chamber. All the ports are submerged when the vortex separator is in use.

To permit the vortex separator to be connected to conventional pipework for liquid flow, a circular-to-rectangular adaptor system is preferably provided, communicating with the inlet port through the curved wall of the chamber and extending to the exterior of the chamber to end in a circular cross-sectional shape adapted for connection to conventional circular pipework and the like. The cross-sectional areas of the two ends will typically be chosen so that the rectangular area is not substantially smaller than the circular area, so as not to constrict any liquid flow between the circular and rectangular ends. Thus, for a vortex separator having the dimensions specifically mentioned above, the radius of the circular end will be in the range of about 4 to about 10 cm, preferably about 5 to about 8 cm.

In one arrangement, the circular end of the adaptor system may be substantially horizontally level with the top of the substantially rectangular inlet port (as in use), as this configuration has been found to give a smooth liquid flow through the adaptor system and the inlet port.

In an alternative arrangement, the circular-to-rectangular adaptor system may comprise a circular inlet pipe which enters the base of a tank disposed exteriorly of the wall of the vortex chamber. The tank is preferably open to the top and covered by a lid in use. In this arrangement, the substantially rectangular inlet port is formed as a substantially rectangular aperture penetrating the wall of the vortex chamber from the tank at the level of the bottom of the tank, thereby providing fluid flow connection between the tank and the vortex chamber.

The tank serves as a header tank to smooth out fluctuations in the inlet flow rate of contaminated fluid and to reduce the fluid flow rate if an upstream feeder pump is being used. The smoothing/reduction of the inlet flow rate can provide for optimum vortexing, as high pressure bursts of the inlet fluid can easily disrupt the vortex in the vortex chamber.

For ease of manufacture of this separator arrangement, and to facilitate stacking of the separators for storage and transportation, that portion of the wall of the vortex chamber which lies above the inlet port and between the vortex chamber and the tank is suitably made to be removable. In one preferred form, the removable wall portion tapers inwardly in the downward direction and is seated on correspondingly tapered formations of the internal wall surface of the vortex chamber. To assist in guiding the parts into seating engagement, and to retain them in position for use, cooperating pairs of rib and recess formations are suitably provided on the meeting surfaces.

The circular end of the circular-to-rectangular inlet adaptor system is suitably provided with a spigot, flange or other conventional connector piece, whereby external pipework can be push, screw, bayonet, snap or otherwise fitted to the adaptor pipe in conventional manner. The circular end of the circular-to-rectangular inlet adaptor system of the separator may be provided with a valve, e.g. a slide valve, so that the separator may be isolated from any upstream feed pipework, pumps, etc. in an emergency. The outlet and discharge ports are suitably provided with connector pieces selected from the conventionally available range.

The vortex separator according to the present invention may be manufactured out of any suitable materials. Most preferred are plastics such as polyethylene (e.g. HDPE) or polypropylene. The materials may, if desired, be reinforced, e.g. by glass fibres. The vortex separator, including the adaptor pipe, is suitably moulded as a unit, the lid being constructed as a separate item adapted to rest or fit (e.g. snap or push fit) onto the rim of the vortex chamber. The lid is suitably moulded from the same material as the vortex separator itself.

The vortex separator is suitably mounted in use on a pedestal base, which supports the vortex chamber. This pedestal base may be integral with the vortex separator or may be constructed as a separate item. The pedestal base is suitably moulded from the same material as the remainder of the separator.

The present invention provide substantial advantages in terms of operating efficiency. Without wishing to be bound by theory, it is believed that the configuration of the inlet port enables the introduced liquid to be delivered more efficiently into the (slower moving) boundary layer of the relatively large mass of liquid, in which in the case of a vortex separator the most efficient separation of contaminants is believed to occur. However, the invention is not to be considered as restricted by this theoretical possibility.

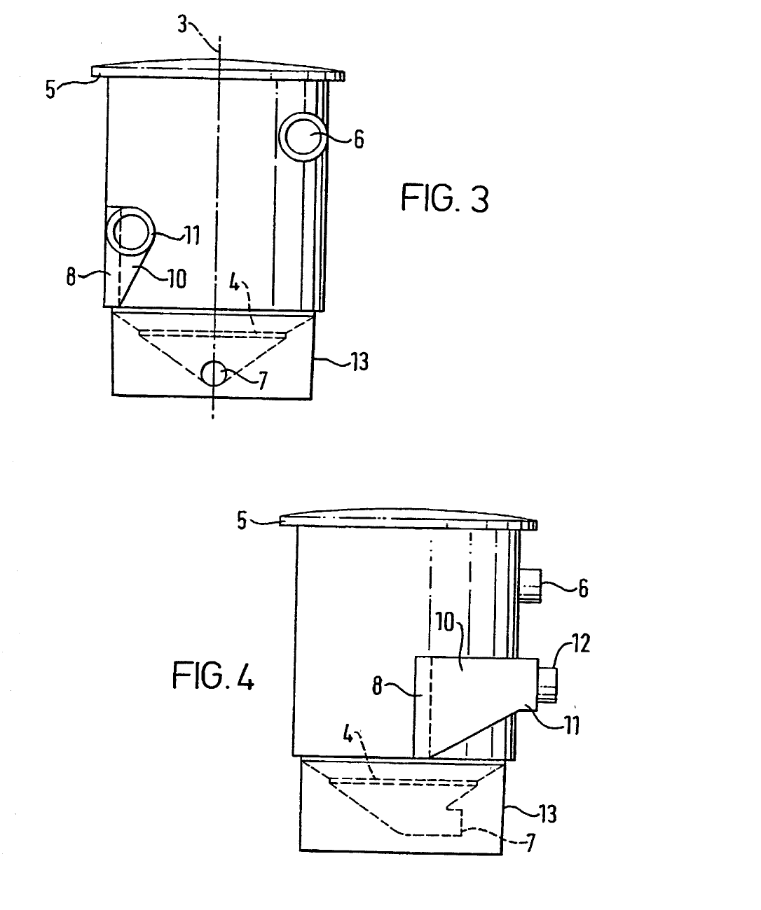

For ease of understanding of the present invention, and to show how the same may be put into effect, embodiments will now be described, purely by way of example and without limitation, with reference to FIGS. 3 to 13 of the accompanying drawings, in which:

FIG. 1 shows a front perspective view of the known vortex separator, as described above;

FIG. 2 shows an interior perspective view of the known separator of FIG. 1;

FIG. 3 shows a front elevation view of a vortex separator according to the present invention;

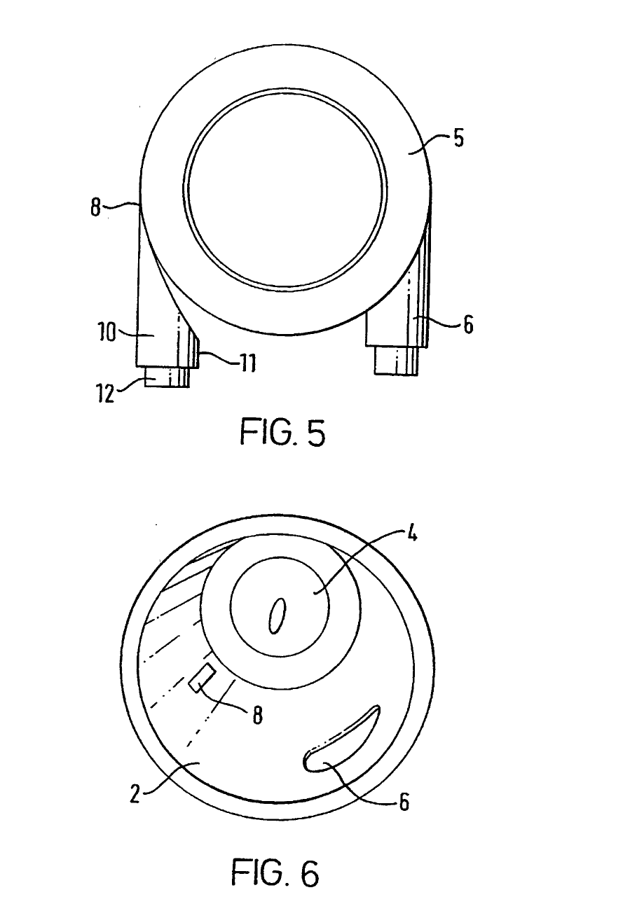

FIG. 4 shows a side elevation view of the vortex separator of FIG. 3;

FIG. 5 shows a top view of the vortex separator of FIG. 3;

FIG. 6 shows an interior perspective view of the chamber of the vortex separator of FIG. 3;

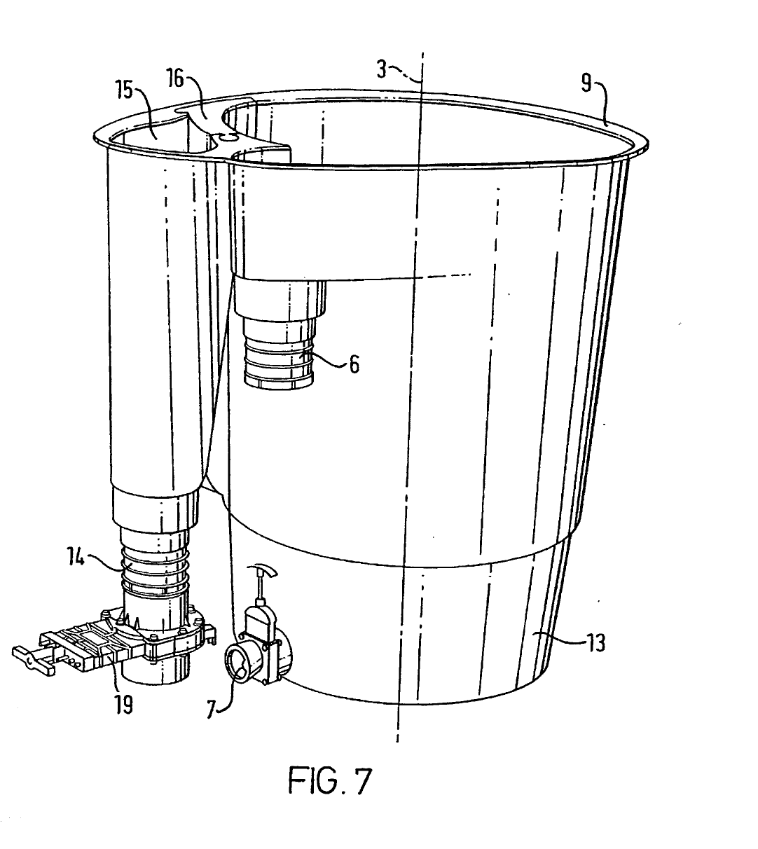

FIG. 7 shows a perspective side view of an alternative vortex separator, according to the invention;

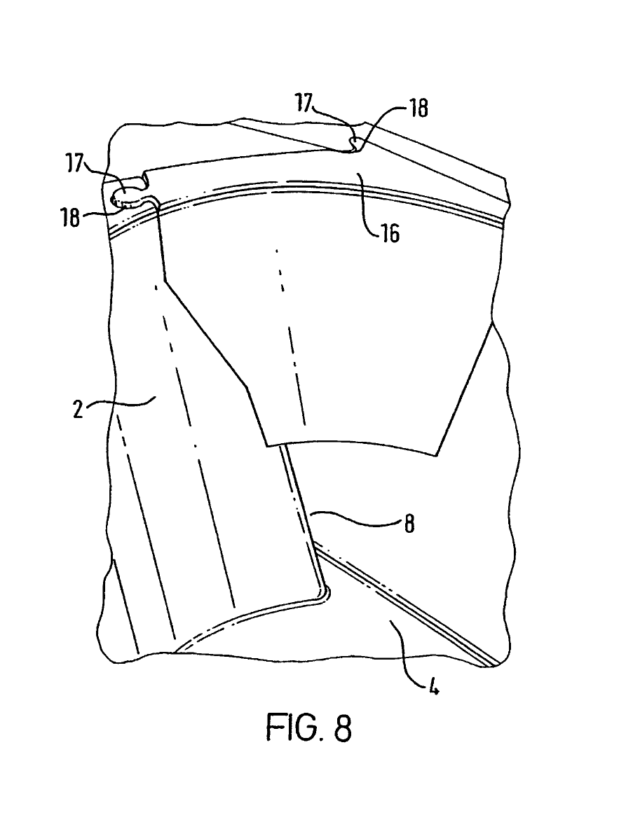

FIG. 8 shows perspective detail of part of the interior wall of the vortex chamber of the separator of FIG. 7, in the region of the inlet port, showing the removable wall portion;

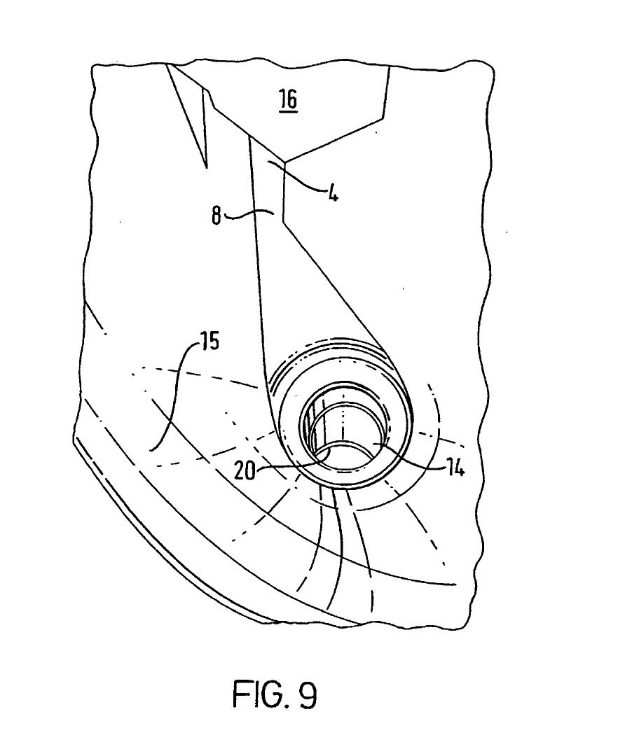

FIG. 9 shows perspective detail of the inlet port of the separator of FIG. 7 from the upstream side, showing the relationship with the upstream header tank and the inlet connector pipe;

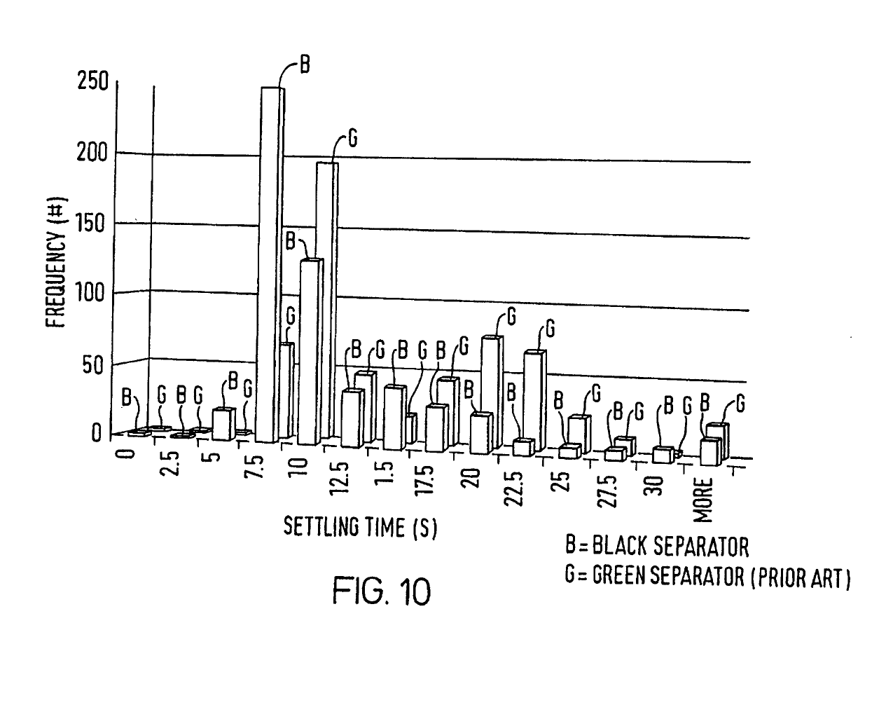

FIG. 10 shows the distribution of residence times for synthetic fish waste in comparative tests on the separators of FIGS. 1 and 2 (“G”) and 3 to 6 (“B”);

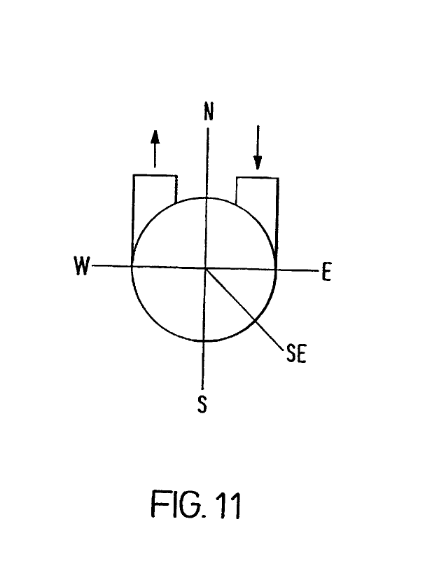

FIG. 11 shows the directional convention employed in the comparative tests;

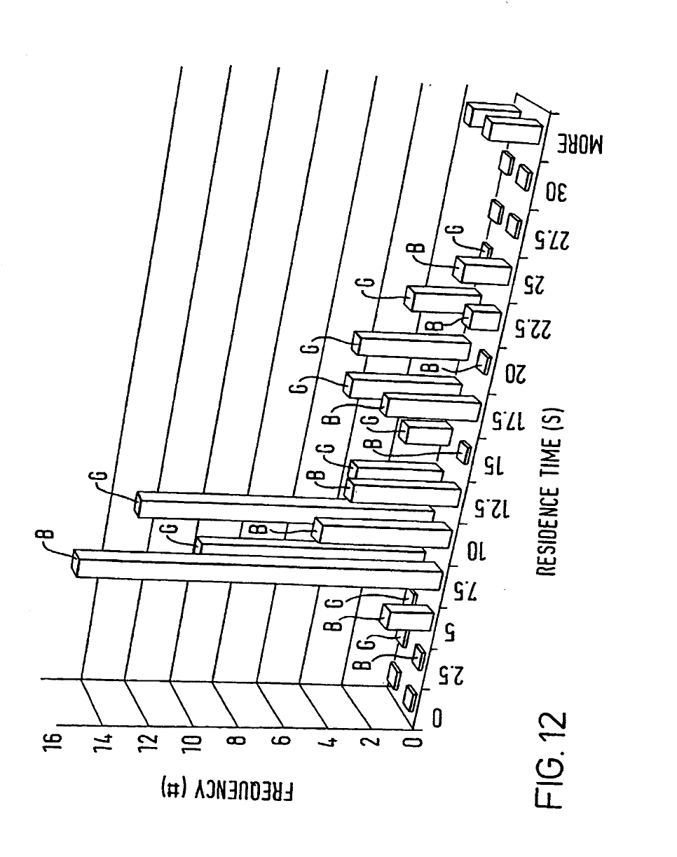

FIG. 12 shows the distribution of measured residence times of the synthetic fish waste in the comparative tests, from which mean residence times are calculated; and

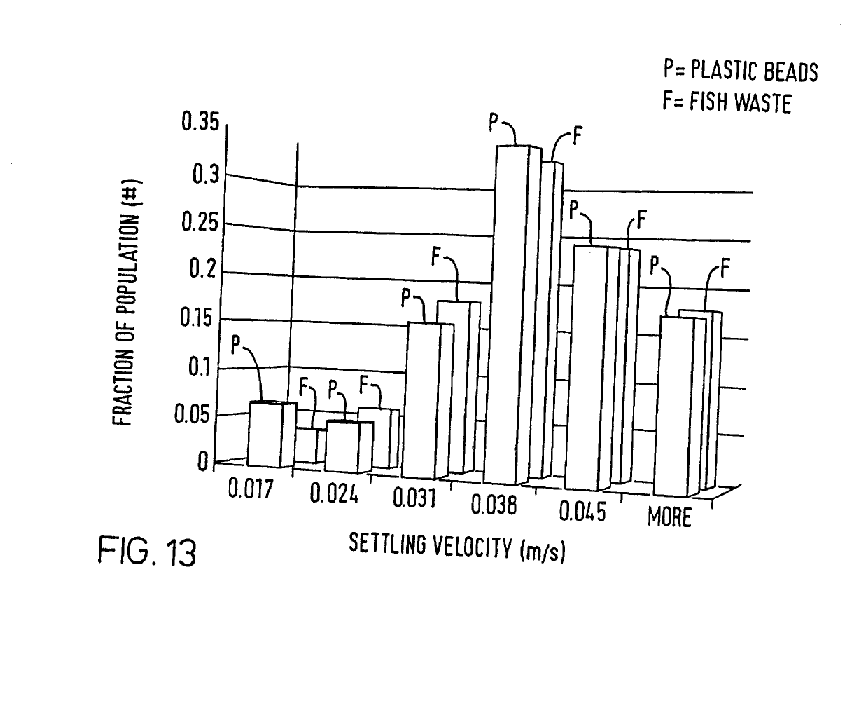

FIG. 13 shows the distribution of measured settling velocities of fish waste in comparative tests on real (“F”) and synthetic (plastic beads) (“P”) fish waste.

Referring firstly to FIGS. 3 to 6, in which like parts are designated as in FIGS. 1 and 2, there is shown a vortex separator for use in removing suspended solids from water. The vortex separator comprises a vortex chamber which in use receives the water via an inlet port 8. The vortex chamber has a curved internal wall surface 2.

As illustrated, the inlet port 8 has a substantially rectangular cross-section at the internal wall surface and is arranged to cause the water to enter the chamber substantially tangentially to the curve of the wall surface.

The curved internal wall of the chamber has a longitudinal axis 3 which in use is orientated generally vertically. The rectangular inlet port 8 has a long axis which is aligned substantially parallel to this longitudinal axis 3 of the curved internal wall, i.e. substantially transverse to the direction of flow of water in the vortex chamber when the separator is in use and the ports are submerged.

The base of the chamber is closed by an end wall 4, which defines a conical hopper where the separated solids collect, and the top of the chamber is closable by a removable lid 5 adapted to rest on a rim 9 of the vortex chamber.

To permit the vortex separator to be connected to conventional pipework for liquid flow, a circular-to-rectangular adaptor pipe 10 is provided, communicating with the inlet port 8 through the curved wall of the chamber and extending to the exterior of the chamber to end in a circular cross-sectional shape 11 provided with an end spigot 12 for connection to conventional circular pipework and the like. The cross-sectional area of the rectangular (inlet port 8) end of the adaptor pipe 10 is no smaller than the cross-sectional area of the circular end 11, so that no constriction of the water flow is caused.

The circular end 11 of the adaptor pipe 10 is substantially horizontally level with the top of the rectangular inlet port 8.

The vortex separator is provided with an outlet port 6 which penetrates the internal wall surface 2, to convey the clean(er) water from the vortex chamber. The outlet port 6 is located somewhat above the inlet port 8, and is arranged so that the water exits the vortex chamber tangentially to the curve of the wall surface 2.

The end wall 4 of the chamber is provided with a conventional solids discharge port 7, whereby the concentrated solids can be removed.

The vortex separator is mounted in use on a pedestal base 13, which supports the vortex chamber.

All parts are preferably formed in moulded plastic materials, the lid 5 and the pedestal base 13 being separable from the remainder (although the pedestal base 13 may alternatively, if desired, be integral with the separator).

Referring now particularly to FIGS. 7 to 9, an alternative separator is shown, in accordance with the present invention. Like parts are designated in like manner to FIGS. 1 to 6.

The primary difference between the separator of FIGS. 3 to 6 and that of FIGS. 7 to 9 lies in the construction of the inlet port 8 and the fluid feed apparatus immediately upstream of the inlet port 8. As shown particularly in FIGS. 7 and 9, the circular-to-rectangular adaptor system immediately upstream of the inlet port 8 comprises a circular inlet pipe 14 which enters the base of a tank 15 disposed exteriorly of the wall of the vortex chamber and open to the top. The tank wall extends to the same top level as the wall of the vortex chamber, as shown in FIG. 7. In use, the lid of the separator (not shown) is shaped to fit over both the vortex chamber and the tank 15.

The rectangular inlet port 8 is formed as a rectangular aperture penetrating the wall of the vortex chamber from the tank at the level of the bottom of the tank 15, and thereby providing fluid flow connection between the tank and the vortex chamber.

The tank 15 serves as a header tank to smooth out fluctuations in the inlet flow rate of contaminated fluid and to reduce the fluid flow rate if an upstream feeder pump is being used. The smoothing/reduction of the inlet flow rate can provide for optimum vortexing, as high pressure bursts of the inlet fluid can easily disrupt the vortex in the vortex chamber.

For ease of manufacture of the separator in molded plastics, and to facilitate stacking of the separators for storage and transportation, that portion 16 of the wall of the vortex chamber which lies above the inlet port 8 and between the vortex chamber and the tank 15 is made to be removable. In the illustrated arrangement, shown particularly in FIG. 8, the wall portion 16 tapers inwardly in the downward direction and is seated on correspondingly tapered formations of the internal wall surface 2 of the vortex chamber. To assist in guiding the parts into seating engagement, and to retain them in position for use, cooperating pairs of rib 17 and recess 18 formations are provided on the meeting surfaces.

A conventional slide valve 19 is provided, associated with the circular inlet pipe 14, which can serve to isolate the separator from upstream pipework, pumps and other apparatus, in the event of an emergency. The valve slide 20 is shown partially closed in FIG. 9.

Comparative Trials

The following report of comparative trials measuring the separation efficiency and other performance of the apparatus of FIGS. 1 and 2 (the so-called “green bin”) against the apparatus of FIGS. 3 to 6 (the so-called “black bin”) is included for further information and to illustrate the advantages of the present invention (the so-called “fishtail” inlet port).

A. Residence Time and Separation Efficiency Tests

For health and safety reasons, real fish waste could not be used for this testing, so an alternative material (plastic beads) was found. Please refer to Section E below, for full details.

A1. Aim

The aim of this set of tests was to compare the old (green) separator with the new (black) separator and to identify whether one performed better than the other. This was done by comparing residence time and separation efficiency.

Residence time was defined as the time between the beads entering the chamber and passing down over the rim of the conical hopper of the end wall 4 of the chamber, the “rim” being the region of the hopper indicated as 4a in FIGS. 2, 3, 4 and 6, which is a small vertical portion of the hopper wall about half-way up the hopper. The rim was chosen as the exit point because any beads that were seen to fall over the rim systematically settled, whereas beads that passed near it and even touched the surface of the hopper above the rim were occasionally seen to rise back up into the main flow of the vortex.

The main objective of this part of the testing was to identify with a 95% confidence level whether the new black separator had a mean residence time at least 1 second less than the old green separator. Further details of the design of experiment associated with this objective are described in Section F below.

A small proportion of the beads that entered the chamber then left with the rest of the effluent via the tangential outlet. In order to ensure that this quantity did not change considerably with the new design, separation efficiency, ηₛₑₚ was measured as function of the mass of beads leaving and settling in the separator:

$${η}_{sep} = \frac{{m}_{settled}}{{m}_{settled} + {m}_{exit}}$$

The second objective of this testing was to ensure that any improvement in residence time was not coupled with a loss in separation efficiency.

A2. Experimental Set-Up

The vortex chamber was filled to within 2 cm of the top and the solids discharge port 7 closed. The tangential effluent outlet port 6 was connected to a pump inlet (not shown) via a flexible hose. A fine mesh filter at the pump inlet caught any beads that left the vortex chamber. The pump outlet (not shown) was connected to the tangential inlet port 1 of the vortex chamber using rigid piping. This rigid piping included a stand pipe (not shown) through which beads could be added to the water entering the separator.

A3. Method

For both the old (green) and new (black) chambers, the following procedure was followed:

The pump was started and the flow regime within the vortex chamber allowed to stabilise for about 10 minutes. The water temperature was taken.

A small quantity of beads (0.3 to 0.4 grams) were dropped into the stand pipe. The time for a bead, chosen at random, to pass from the inlet to the rim of the conical collection hopper was recorded.

The above was repeated 570 times.

Once the times had been recorded, the temperature was taken again and the circuit was drained, taking care not to lose any beads.

Beads from the filter in the pump and from the collection hopper were dried and weighed.

A4. Results

The distribution of residence times for beads in the old (green, “G”) and new (black, “B”) vortex chambers is shown in FIG. 7. These results are summarised in Table I below:

TABLE I

| | Old (green) | New (black) |
|---|---|---|
| Mean Residence time [s] | 14.68 | 10.63 |
| Variance [s] | 87.11 | 60.97 |
| Sample size [#] | 570 | 570 |
| Median [s] | 11.08 | 7.22 |
| Mode [s] | 8.98 | 6.25 |
| Separation efficiency [%] | 93.7 | 94.6 |

A5. Discussion

A5.1 Experimental Error

It is estimated that the error in residence time measurements is about ±0.4 seconds, from slow reaction times in starting and stopping the stop watch.

It is estimated that the error associated with the efficiency results is of the order ±0.1%, from beads lost or extras being accidentally added to the samples.

A5.2 Residence Times

It can be concluded with 95% confidence that there is a 1 second improvement (reduction) in residence time with the new ‘fishtail’ inlet. Although there is a marked (4.05 second) improvement from the old (green) separator to the new black separator, on the basis of Table I, the experiment was designed such that a certain hypothesis is tested (i.e. that there is a 1 second improvement associated with the fishtail inlet), so the remark that “there is a 4 second improvement” is not entirely correct as a scientifically proven statement. In order to prove such a statement, a further test would have to be run with a much larger sample size.

Inaccuracies in time-keeping are not sufficient to alter the result that the fishtail inlet improves performance.

The green separator has two modes, one of 8.98 seconds, the other at about 20 seconds. The first represents beads that enter the chamber and fall straight out of the main flow and into the collection hopper. The second mode represents beads that fall out more slowly, arrive at the rim, and cannot pass over it into the collection hopper for up to half a revolution, so are not deemed to have settled. The region over which beads cannot pass over the rim is roughly from south-west (“S-W”) to north-east (“N-E”) (see FIG. 8). It would appear that the vortex is either elliptical or not completely co-axial with the chamber, such that over this region fluid pushes the beads away from the centre of the chamber, impeding their path to the collection hopper There is only one mode in the results from the black separator, at 6.25 seconds, implying that no such eccentricity in flow regime is present.

If one were to consider the results without the second mode in the green chamber, one would see that a subtle improvement in residence time is still gained with the fishtail inlet. The following is an explanation of this:

Given that the vast majority of the beads in the black chamber entered through the uppermost of the inlet slots, the vertical distance that the beads had to travel in each case is roughly similar (0.38 metres in the black chamber and 0.35 metres in the green chamber). A vertical velocity of beads can now be calculated in each case, using the modal time (used because in the case of the green separator the average time includes both modes, of which the second does not represent an unimpeded journey through the water). This results in vertical velocities for the green separator of 0.038 m/s and 0.061 m/s for the black separator. In previous tests the mean setting velocity of beads in water was measured as 0.035 m/s. The settling velocity in the green separator is near enough to the settling velocity of beads in still water, but the result of the black separator is higher. The reason for this may be a downward current that is aiding the separation of the beads. This is reasonable, given the geometry of the fishtail inlet in the black separator.

A5.3 Separation Efficiency

There seems to be no loss of separation efficiency when using the fishtail inlet on the black separator. The difference in efficiency that is seen is within the realms of experimental error and can be said to be zero.

A5.4 General

The pattern of settled beads in the hopper of the black chamber was markedly different to that in the green. Beads in the green separator would collect in a roughly conical pile in the centre of the hopper. Beads in the black separator would settle as soon as they touched the surface of the collection hopper, leaving a finely dispersed carpet of beads all over the bottom surface of the separator. Consequently, a larger solids discharge port will be needed to flush the collection hopper, reducing its efficiency.

B. Velocity Profiles

B1. Aims

The aim of this piece of work was to take velocity measurements of the water in the old (green) and new (black) vortex chambers in order to clarify the behaviours seen in the residence time testing.

B2. Experimental Set-Up

The vortex chamber and circuit were set up as described in Section A above (residence time testing). A frame was hung on the rim of the chamber, from which the velocity measurement probe was suspended.

A Nortex(TM) Acoustic Doppler Velocity (ADV) probe was used to measure the water velocity. The probe measures velocities in three axes in a control volume that is approximately 50 mm below the probe itself Hence the flow through the control volume is relatively undisturbed by the presence of the probe.

B3. Method

Two sets of velocity tests were carried out on each chamber. The first was a general preview of the whole chamber, the second a more in-depth investigation into the flow regime around the inlet For the first set of tests the following procedure was used:

The probe was attached to the frame such that it was parallel to the axis of the chamber and gave as little resistance to flow as possible.

At the ‘north’ position (see FIG. 8), the probe was positioned as high in the water (depth=20 cm) and as near to the rim as possible (radius=32 cm). Velocities in three axes were taken over a five second average.

The probe was moved toward the centre of the chamber in 5 cm increments and velocity measurements were taken (radius=32, 27, 22, 17, 12 and 7 cm).

The probe was lowered 5 cm into the water and another sweep taken, building up a mesh (depth=20, 25, 30, 35, 40, 45, 50, 55, 60, 65, 70 and 75 cm).

The same sweeps were repeated at the ‘east’, ‘south’ and ‘west’ positions (see FIG. 8).

The second set of testing aimed at collecting more information about the flow at the inlet.

The probe was attached to the frame at an angle of 45° so that the velocity at the chamber wall could be measured.

At the ‘east’ position the probe was positioned a little above the inlet (depth=35 cm) and at 0 cm from the chamber wall. The velocity was taken, using a 5 second average.

The probe was moved radially inwards in increments of 1 cm, then of 2 cm, and velocity measurements were taken (radius=37, 36, 35, 34, 33, 32, 31, 29, 27, 25, 23, 21, 19 and 17 cm).

The probe was lowered 5 cm into the water and another sweep taken, building up a mesh (depth=35, 40, 45, 50, 55, 60, 65, 70 and 75 cm).

Identical sweeps were taken at the ‘south-east’ and ‘south’ positions.

B4. Results and Discussion

B4.1 First Batch—North, East, South and West

The total velocity in the range −10.00 to +38.00 cm/s was measured at the north, east, south and west positions in both the old (green) and new (black) chambers. There is no evidence of a boundary layer (nearest to the rim that was measured is 5 cm). In almost all cases there appears to be a slower region at depth=75 cm and radius=32 cm, which corresponds to the surface of the conical hopper.

Both chambers appear to have a general flow regime consistent with a forced or rotational vortex in which all particles have the same angular velocity (i.e. the fluid rotates as a solid body). An exception is the ‘east’ measurements, were the inlet applies the torque that drives the vortex. Although there are some fluctuations from the ideal model of a forced vortex, the general flow regime is far closer to a forced vortex than a free or irrotational vortex.

The results for ‘east’ (i.e. next to the inlet) for both chambers show that the shapes of the inlets are influential—circular in the case of the old green chamber and elongated in the case of the new black chamber.

In the green chamber there is found to be still an area of high velocity in the ‘south’ results which corresponds to the jet from the inlet, whereas the inlet jet in the black ‘south’ results has either dissipated of is off the range measured. The jet in the green results is also nearly out of the range measured.

Velocities in the green chamber were found to be generally faster than those in the black chamber. There was found to be a wide column of almost stationary fluid at the centre of the black chamber which is less pronounced in the green chamber. This is understandable in view of the geometry of the two chambers: the inlet of the green chamber is on a smaller radius, and so will entrain fluid near the centre to give rise to faster central fluid, whereas the inlet jet of the black chamber is on a larger radius, and so will not have such a great influence on fluid near the centre of the vortex.

The flow in both chambers seems to be relatively well centred and circular.

B4.2 Second Batch—East, South-East & South

Once again, the same general flow regimes are evident. In particular, the shapes of the inlets are seen to be influential, i.e. visible effects of the circular jet in the green results and the elongated jet in the black results. The high speed flow in the black vortex seems to be more concentrated towards the outside of the chamber, as explained in the previous section.

In these tests, the probe gave erroneous results in the boundary region because of the presence of the wall. Evidence of the boundary layer is therefore not very strong, although it is believed to exist.

There may be a larger error in measurements in this second batch than in the first, as the mounting of the probe was much bigger and liable to cause a bigger disturbance to flow. In addition, errors may increase as the deeper the probe was positioned as there was a greater resistance to flow.

There appears to be a slight downward flow in the black chamber towards the circumference and an upward flow towards the centre of the chamber. Although these trends are present in the green chamber, they are not as evident.

C. General Discussion

In the following discussion, the bibliographic references are as listed in Section G below, which also lists other references of general background interest.

Certain trends are evident in both the velocity testing and the residence time testing.

The more widespread distribution of settled beads in the collection hopper of the black vortex is understandable, in view of the generally lower fluid velocity. Beads are not imparted with as much energy by the fluid, so they tend to settle and remain stationary as soon as they hit the hopper surface; they do not have ‘extra’ energy to overcome friction and slid to the solids discharge port 7 at the bottom.

It was conjectured that there may be a downward element to the inlet jet in the black chamber (the geometry of the inlet and the considerably higher setting velocities would imply as much). This conjecture was borne out by the velocity profile generated in the second set of testing (black south-east and south).

The general flow patterns observed are similar to those measured in other vortex separators.

At low velocities, Smisson [1] observed a forced vortex in the outer region of his separators, although the free vortex in the centre of the chamber is absent in this investigation. This is barely surprising given the vastly different dimensions of combined sewer overflows (CSOs) and the higher flow rate that they are expected to cope with.

Andoh [2] commented on two separate flow regimes in CSOs, there being a general downward flow in the outer region and upward flow in the inner region, as seen in Nitritech's vortex chamber, but not as strongly. However these flows are, if not induced, at least aided by a multiplicity of internal components that direct the flow in CSOs. These components are absent fromNitritech's separator, and their inclusion may be more costly than the benefits are worth.

D. Conclusions

The following conclusions can be drawn:

The inclusion of a fishtail inlet has led to a marked improvement in residence time of beads in the separation chamber. With a confidence level of 95%, it can be stated that the new design reduces residence time by 1 second.

The new fishtail inlet does not degrade separation efficiency. Levels of about 95% were recorded for both the old and new designs.

The distribution of settled particles on the chamber floor is dramatically changed by the new inlet. Where there was a neat pile of collected debris at the bottom of the chamber in the old design, particles are finely scattered over the chamber floor in the new chamber. A reasonable explanation of this phenomenon has been proffered.

The flow regimes in both the old and new chambers are borne out in both tests and generally seem to accord with the experience of other authors.

E. Preparation of the Synthetic Fish Waste

Due to obvious health and safety issues, a real fish waste could not be used for settling rates and separation efficiency measurements. Tests were therefore run to find a suitable alternative.

E.1 Method

Settling velocity in water was considered to be a good criteria by which to judge potential fish waste alternatives.

Fish waste was dropped into a column of water 50 cm deep and 8 cm in diameter.

The time to settle was measured over 37 cm.

Those samples that came into contact with the surface of the containers were included in the sample, as tests in the vortex separators would also include contact with the container surface.

Data was collated and the means and standard deviation calculated.

The procedure was repeated for other, non-organic materials.

E.2 Results

Of all the results, only the finally chosen material and the original fish waste is shown in FIG. 9. The results are summarised in Table II below:

TABLE II

| | Fish Waste | Plastic Beads |
|---|---|---|
| Mean velocity [m/s] | 0.0350 | 0.0351 |
| Variance [m/s] | 0.0088 | 0.0095 |
| Sample size [#] | 34 | 124 |
| Density [kg/m³] | 1019 | 1149 |
| Mean particle diameter [mm] | 4 | 3 |
| Mean particle length [mm] | 6 | 3 |

E.3 Discussion

The plastic beads seem to behave very similarly to real fish waste when considering the settling velocity. Not only is the average velocity the same, but there is a very similar spread in the results.

The wide distribution of the fish waste settling velocities was probably due to their organic nature—no two fish are the same. The plastic beads (originally used for injection moulding) have avery small capillary (diameter 0.5 mm) running up the centre line. This capillary filled with water in some instances and contained an air pocket in others changing the buoyancy characteristics, hence the wide distribution of settling velocities for the beads.

Other materials tested had very different settling velocities, ranging from 0.011 m/s to 0.112 m/s.

E.4 Conclusion

The plastic beads were considered a suitable alternative for fish waste. It may be prudent to validate tests run with these beads, by re-running them with real fish waste.

F. Design of Experiment-Residence Times

In order to quantify which of the two separators—the old (green) of new (black)—was better, the chosen measure was the mean time for beads to settle to the bottom, or residence time.

Initial tests with each separator yielded the data on residence time shown in FIG. 10, which is summarised in Table III below.

TABLE III

| | Old (green) | New (black) |
|---|---|---|
| Mean Residence time [s] | 12.70 | 11.78 |
| Variance [s] | 48.69 | 127.85 |
| Sample size [#] | 44 | 37 |

From this data, it is possible to ascertain the sample size one would need to collect in order to prove that the one is better than the other with a given degree of confidence (Diamond [8]).

F.1.1 Define the Object of the Experiment

Null hypothesis, H₀:t_{r.green}=t_{r.black}

Alternative hypothesis, Hₐ:t_{r.green}>t_{r.black}

F.1.2 Define Limits and Confidence Level

Confidence in null hypothesis, α=0.05

Confidence in alternative hypothesis, α=0.05

Difference, δ=1.0 seconds

Variance, S_{g}²=48.69, degrees of freedom, φ_{g}=44

Variance, S_{b}²=127, degrees of freedom, φ_{b}=37

F.1.3 Determine Deviates and Sample Size

Given α-0.05, φ=40, t_{0.05}=1.69

Given β=0.05, φ=40, t_{0.05}=1.69

$$N = {( {t}_{α} + {t}_{β} )}^{2} \frac{{S}^{2}}{{δ}^{2}} = {( 1.69 + 1.69 )}^{2} \frac{49}{1} = 560$$

F.1.4 Compute Criterion

$$\overline{X} = {t}_{r} - \frac{{t}_{a} S}{\sqrt{ N}} = 12.7 - \frac{1.69 \times 7}{\sqrt{560}} = 12.20$$

Hence, to prove with 95% confidence that the new (black) separator has an average residence time 1 second less than that of the old (green) separator, 560 samples of each must be tested, and the mean residence time of the black must be less than 12.20 seconds.

### G. REFERENCES

[1] Smisson B “Design, construction and performance of vortex overflows” Institute of Civil Engineers, Symposium on Storm Sewage Overflows, London 1967.

Andoh RYG “The StormKing overflow hydrodynamic separator” Conference proceedings of Alleviating Problems of SCOs within the Piped System, H R Warrington, April 1994.

[3] Tyack J N, Fenner R A “Computational fluid dynamics modelling of the velocity profiles within a hydrodynamic separator”, Water Science and Technology, ISSN 0273-1223, Volume 39, Issue 9, pp 169-176.

[4] Saul A J, Svenjkovski K “Computational modelling of a vortex CSO structure” Water Science Technology, Vol. 30, No. 1, pp 97-106, 1994.

[5] Harwood R, Saul A J “CFD and novel technology in combined sewer overflow” 7^{th} International Conference on Urban Storm Drainage, Hanover, Germany, 1996, pp 1025-1030.

[6] Saul A J, Harwood R “Gross solid retention efficiency of hydrodynamic separator CSOs” Proceedings of the Institute of Engineers, Water & Maritime Energy, June 1998, Vol. 130, pp 70-83.

[7] Hubner M, Geiger W F “Review of hydrodynamic separator-regulator efficiencies for practical application” Water Science & Technology, Vol. 32, No. 1,pp 109-117, 1995.

[8] Diamond W J “Practical experiment design for engineers and scientists”, 1981 (512.79 DIA).

Other Related Texts:

Fenner R A, Tyack J N “Scaling laws for hydrodynamic separators” ASCE Journal of Environmental Engineering, Vol. 123, No. 10, October 1997, pp 1019-1026.

Fenner R A, Tyack J N “Physical modelling of hydrodynamic separators operating with a baseflow”, ASCE Journal of Environmental Engineering, Vol. 124, No. 9, September 1998, pp 881-886.

Field R “The dual functioning swirl combined sewer overflow regulator/concentrator” Water Research, Vol. 9, pp 507-512.

Field R O'Connor T P “Swirl Technology: enhancement of design, evaluation and application” Journal of Environmental Engineering, August 1996, pp 741-748.

The foregoing broadly describes the present invention without limitation to the particular illustrated embodiment Variations and modifications as will be readily apparent to one of ordinary skill are intended to be included within the scope of this application and subsequent patent(s). In general, the broad scope of this invention is to be determined from the following claims, when properly interpreted in the manner prescribed by law and precedent.

1. A vortex separator for use in at least partially removing suspended solids from a liquid, the vortex separator comprising:
(a) a vortex chamber having (i) a curved internal wall surface which has a longitudinal axis which in use is orientated substantially vertically, and (ii) an end wall closing a base of the chamber,
(b) an inlet port for the liquid, which penetrates the curved internal surface and is arranged to cause the liquid to enter the chamber substantially tangentially to the curve of the wall surface;
(c) an outlet port for the liquid, which penetrates the curved internal wall surface and is arranged to convey the liquid from the chamber after at least some of the suspended solids have been separated from the liquid; and
(d) a discharge port for the suspended solids;
wherein the inlet port has a substantially rectangular cross-section at the internal wall surface of the chamber.

2. A vortex separator as claimed in claim 1, wherein the long axis of the rectangle of the cross-section of the inlet port is aligned substantially transverse to the direction of flow of liquid in the vortex chamber.

3. A vortex separator as claimed in claim 1 or claim 2, wherein the ratio of the long:short sides of the rectangle of the cross-section of the inlet port is in the range about 3:1 to about 15:1, preferably about 7:1.

4. A vortex separator as claimed in any one of claims 1 to 3, wherein the inlet port has a short side dimension which is not substantially greater than the thickness of the boundary layer of the liquid in the vortex chamber in use.

5. A vortex separator as claimed in any one of the preceding claims, wherein the vortex chamber has a chamber capacity of between about 0.5 and about 1.5 cubic metres and an optimum liquid through-flow rate of between about 7 and about 13 cubic metres per hour, and the inlet port has a short side of between about 1 cm and about 10 cm, preferably about 5 to about 8 cm in length.

6. A vortex separator as claimed in any one of the preceding claims, wherein the inlet port penetrates the internal wall surface of the vortex chamber over a top to bottom length corresponding to the majority of the lower half of the chamber.

7. A vortex separator as claimed in any one of the preceding claims, wherein the top of the inlet port is below the outlet port.

8. A vortex separator as claimed in any one of the preceding claims, wherein the outlet port penetrates the curved internal wall surface tangentially.

9. A vortex separator as claimed in any one of the preceding claims, wherein to permit the vortex separator to be connected to conventional circular cross-section pipework for liquid flow a rectangular-to-circular adaptor system is provided, communicating with the inlet port through the curved wall of the vortex chamber and extending to the exterior of the chamber to end in a circular cross-sectional shape adapted for connection to the said pipework.

10. A vortex separator as claimed in claim 9, wherein the circular end of the adaptor system is substantially horizontally level with the top of the substantially rectangular inlet port.

11. A vortex separator as claimed in claim 9, wherein the rectangular-to-circular adaptor system comprises a generally circular inlet pipe which enters the base of a tank disposed exteriorly of the wall of the vortex chamber, the substantially rectangular inlet port being provided as a substantially rectangular aperture penetrating the wall of the vortex chamber with fluid flow connection therethrough between the tank and the vortex chamber.

12. A vortex separator as claimed in claim 11, wherein the substantially rectangular aperture penetrates the wall of the vortex chamber at the general level of the bottom of the tank.

13. A vortex separator as claimed in claim 11 or 12, wherein the tank is open to the top.

14. A vortex separator as claimed in any one of claims 11 to 13, wherein a portion of the wall of the vortex chamber which lies above the inlet port and between the vortex chamber and the tank is adapted to be removable.

15. A vortex separator as claimed in claim 14, wherein the removable wall portion tapers inwardly in the downward direction and is adapted to be seated on correspondingly tapered formations of the internal wall surface of the vortex chamber.

16. A vortex separator as claimed in claim 14 or 15, wherein cooperating pairs of rib and recess formations are suitably provided on the meeting surfaces of the removable wall portion and the internal wall surface of the vortex chamber.

17. A vortex separator as claimed in any one of claims 9 to 16, wherein the rectangular cross-sectional area of the adaptor system is at least substantially the same as the circular cross-sectional area thereof.

18. A method for introducing a moving liquid into a larger mass of liquid moving in an apparatus, the method comprising introducing the first moving liquid into the second via an inlet port which penetrates an internal wall surface of the apparatus, the inlet port having a substantially rectangular cross-section and being arranged so that the introduced moving liquid enters the larger moving mass of liquid at the internal wall surface at a sufficiently small angle to the direction of flow of the larger moving mass of liquid at the internal S wall surface that the introduced liquid is substantially maintained in the boundary layer of the larger mass of liquid at the internal wall surface.

19. An apparatus adapted to contain a relatively large mass of liquid moving therein, and to permit a relatively small mass of moving liquid to be introduced into the relatively large mass, the apparatus having an internal wall surface and comprising an inlet port for the liquid to be introduced, the inlet port penetrating the internal wall surface of the apparatus, wherein the inlet port has a substantially rectangular cross-section and is arranged so that in use the introduced moving liquid enters the larger mass of liquid at the internal wall surface at a sufficiently small angle to the direction of flow of the larger moving mass of liquid that the introduced liquid is substantially maintained in the boundary layer of the larger mass of liquid at the internal wall surface.
